(19) United States
(12) Patent Application Publication
(10) Pub. No.: US 2026/0348398 A1
(43) Pub. Date: Nov. 5, 2026

(54) FIXED VANE ASSEMBLY FOR A TURBINE ENGINE COMPRISING VARIABLE-PITCH VANES

(71) Applicant: Safran Aircraft Engines, PARIS (FR)

(72) Inventors: Celia IGLESIAS CANO, MOISSY-CRAMAYEL (FR); Vincent JOUDON, MOISSY-CRAMAYEL (FR)

(73) Assignee: Safran Aircraft Engines, PARIS (FR)

(21) Appl. No.: 19/105,079

(22) PCT Filed: Aug. 21, 2023
(86) PCT No.: PCT/FR2023/051284

§ 371 Date: Feb. 20, 2025

(30) Foreign Application Priority Data
Aug. 22, 2022 (FR) FR2208437

(51) Int. Cl. F04D 29/56; F04D 19/00; F04D 29/02

(52) U.S. Cl. CPC F04D 29/56; F04D 19/00; F04D 29/023; F05D 2260/31; F05D 2260/36; F05D 2300/603

(57) ABSTRACT

The present application relates to a blade (3) of a static vane assembly (2) of a turbine engine (1) comprising:—a blade root (8) comprising a fibrous reinforcer (13) comprising a first skin (12) and a second skin (12) separated by a cavity (14) that opens onto a lower face (15) of the blade root (8);—a fastener (6) configured to receive the blade root (8) and attach it to a hub (4) of the vane assembly (2), the fastener (6) comprising a platform (16) and a rib (17) protruding from the platform (16), the rib (17) being configured to penetrate the cavity (14) so as to extend between internal faces (12a) of the first skin (12) and of the second skin (12); and—an attachment system (18) configured to mechanically attach the first skin (12) and the second skin (12) to the rib (17) of the fastener (6).

This Application is a National Stage of International Application No. PCT/FR2023/051284 filed Aug. 21, 2023, claiming priority based on French Patent Application No. 2208437 filed Aug. 22, 2022, the contents of each of which being herein incorporated by reference in their entireties.

### TECHNICAL FIELD

This application relates to the field of turbomachines, in particular a fixed vane assembly of a turbomachine, for example a fixed vane assembly comprising variable-pitch stator vanes, each attached to a pivot. The invention is in particular applicable to the unducted guide vane of a turbomachine or to the ducted guide vane of a turbomachine.

### PRIOR ART

Turbomachines comprising at least one unducted propeller are known as “open rotor” or “unducted fan” turbomachines. Such turbomachines may comprise two unducted and contrarotating propellers (known by the acronym CROR for Contra-Rotating Open Rotor) or a single unducted propeller and a guide vane comprising several stator vanes (known by the acronym USF for Unducted Single Fan). The propellers can be placed aft of the gas generator (or engine) so as to be of push type or forward of the gas generator so as to be of pull type. These turbomachines are turboprop engines which are distinguished from turbojet engines by the use of a propeller outside the nacelle (unducted) instead of an inner fan. This makes it possible to increase the bypass ratio very significantly without being penalized by the mass of the casings or nacelles intended to surround the vanes of the propeller or fan.

The stator vanes of the guide vane are generally installed on a hub which carries the splitter of the primary and secondary flows circulating in a primary air path and around the inlet casing respectively. Unlike the upstream propeller of a turbomachine of USF type, the stator vanes of the guide vane are rotationally fixed with respect to the axis of rotation of the upstream propeller and consequently do not undergo any centrifugal force.

The stator vanes extend from the inlet casing and are advantageously of variable pitch. For this purpose, each stator vane root is mounted pivotably along a pitch axis and connected to a pitch change system mounted in the turbomachine. The area of integration of the root and of the pivot of the stator vane is a heavily-stressed area due to the presence of many equipment items around them.

Furthermore, in such turbomachines for which weight savings are desirable, the stator vanes are preferably made of composite material comprising a fiber reinforcement embedded in an organic matrix.

Current propeller attachment technologies do not, however, meet the need for attaching the stator vanes of a USF-type turbomachine since they are configured to press the root of the vane assembly down in a recess attachment using the centrifugal forces generated by the rotation of the vane assembly. However, in a static vane assembly, the absence of rotation and thus of centrifugal force prevents recourse to this simple and well-known means of attachment. The vanes of static vane assemblies are therefore generally attached by bolting onto a metallic fastener. These fasteners are however radially or tangentially bulky, which makes them difficult to incorporate into the turbomachine.

### SUMMARY

One aim of this application is to remedy the aforementioned drawbacks, by making provision for a system for attaching the variable-pitch vanes of a static vane assembly of a turbomachine, which is of reduced radial and tangential bulk while guaranteeing a suitable retainment of the vanes of the static vane assembly.

For this purpose provision is made, according to a first aspect, for a vane of a static vane assembly of a turbomachine comprising:
a vane root comprising a fiber reinforcement embedded in a matrix, the fiber reinforcement comprising a first skin and a second skin separated by a cavity open onto a lower face of the vane root;
a fastener configured to receive the vane root and to attach it to a hub of the vane assembly, the fastener comprising a platform and a rib protruding from the platform, the rib being configured to enter into the cavity so as to extend between inner faces of the first skin and of the second skin; and
an attaching system configured to mechanically attach the first skin and the second skin to the rib of the fastener.

Certain preferred but non-limiting features of the vane according to the first aspect are as follows, taken individually or in combination:
the attaching system traverses the first skin, the rib and the second skin;
the rib comprises two side faces connected to the platform and an apex connecting the two side faces, a thickness of the rib being decreasing from the platform in the direction of the apex and the inner faces of the skins can be more flared than the side faces of the rib; in a variant, the rib comprises two side faces connected to the platform and an apex connecting the two side faces, a thickness of the rib being substantially constant from the platform in the direction of the apex; according to yet another variant, the rib comprises two concave curved side faces such that a thickness of the rib decreases from the platform in the direction of the apex;
the first and the second skin are moreover in abutment against the platform;
the attaching system comprises at least one of the following elements: a bolt; a plate shaped to come into contact with an outer face of the skins;
the attaching system comprises a bolt traversing the first skin, the rib and the second skin;
the vane further comprises a shaping part housed in the cavity distant from an apex of the rib;
the shaping part comprises an additional composite material comprising an additional fiber reinforcement embedded in an additional matrix, the additional fiber reinforcement comprising fibers having a Young modulus at least equal to 5 GPa, for example fibers of carbon, aramid, glass or basalt;
the vane further comprises a filling part housed in the cavity between an apex of the vane and the shaping part, the filling part being able to comprise a material, a density of which is less than the density of the composite material;
the fiber reinforcement has an upstream edge and a downstream edge, the cavity being moreover open onto at least one from among the upstream edge and the downstream edge; and/or
the fastener is a pivot.

According to a second aspect, provision is made for a static vane assembly of a turbomachine comprising at least one vane in accordance with the first aspect and a hub, the fastener of the vane being mounted pivotably on the hub about a pitch axis.

According to a third aspect, provision is made for a turbomachine comprising a static vane assembly in accordance with the second aspect, further comprising a ducted fan or an unducted propeller, a compression section and a turbine section, the static vane assembly being at least one of the following vane assemblies: a ducted guide vane of the fan, an unducted guide vane of the propeller, a guide vane of the compression section, a nozzle of the turbine section.

According to a fourth aspect, provision is made for an aircraft comprising at least one turbomachine in accordance with the third aspect, which can be attached to the aircraft using a pylon.

According to a fifth aspect, provision is made for a method for manufacturing a vane in accordance with the first aspect comprising the following steps:
producing a vane root comprising a fiber reinforcement embedded in a matrix, the fiber reinforcement comprising a first skin and a second skin separated by a cavity open onto a lower face of the fiber reinforcement;
inserting a rib of a fastener into the cavity of the vane root such that the rib extends between inner faces of the first skin and of the second skin and a platform extends outside the cavity;
mechanically attaching the first skin and the second skin to the rib of the fastener.

Optionally, the step of producing the vane root comprises the following sub-steps, prior to the step of inserting the rib:
successively inserting at least one filling part and at least one shaping part into the cavity;
placing the assembly formed by the fiber reinforcement, the at least one filling part and the at least one shaping part into a mold, and
injecting the matrix.

### DESCRIPTION OF THE FIGURES

Other features, aims and advantages of the invention will become apparent from the following description, which is purely illustrative and non-limiting, and which must be read with reference to the appended drawings on which:

FIG. 1 is a schematic section view of an exemplary embodiment of a vane in accordance with a first embodiment of the invention;

FIG. 2 is a perspective and schematic view of an exemplary embodiment of a fiber reinforcement which can be used for the production of a vane in accordance with an embodiment of the invention;

FIG. 3 a schematic section view of an exemplary embodiment of a vane in accordance with a second embodiment of the invention;

FIG. 4 is a schematic, axial and partial section view of an example of a turbomachine of USF type comprising a single unducted propeller and an unducted guide vane to which the invention is applicable; and

FIG. 5 is a schematic view of an example of an aircraft which may comprise at least one turbomachine in accordance with an embodiment of the invention.

On all the figures, similar elements bear identical reference numbers.

### DETAILED DESCRIPTION OF THE INVENTION

A turbomachine 1, particularly for an aircraft 100, conventionally comprises at least one fan or at least one propeller 26, a compression section 27, a combustion chamber 28, a turbine section 29 downstream of the combustion chamber 28, and an exhaust casing.

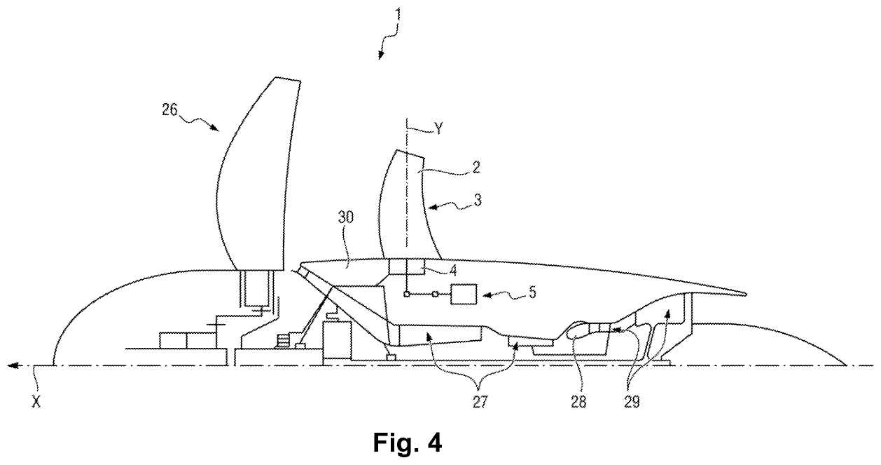

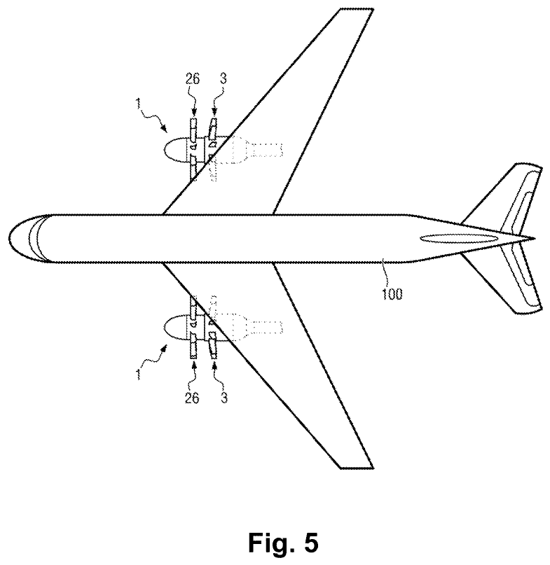

The invention is applicable to any static (i.e. non-rotary) vane assembly 2 of a turbomachine 1, whether it is a guide vane assembly 2 of a fan or of a propeller 26, a guide vane assembly 2 of the compression section 27 or a nozzle guide vane assembly 2 of the turbine section 29. By way of example, the turbomachine 1 can in particular be a turboprop engine of USF type comprising an unducted propeller 26, in which case the static vane assembly 2 is unducted and extends downstream of the propeller (see FIG. 4). In another example, the turbomachine 1 can be a turbojet engine comprising a ducted fan, in which case the static vane assembly 2 can be the ducted guide vane extending downstream of the fan which is known by the name of “outer guide vane”.

In this application, the upstream and the downstream are defined with respect to the direction of flow of the gas through the static vane assembly 2. The term “X axis” refers to the axis of rotation of the rotor of the propeller 26 (or of the fan respectively). The axial direction corresponds to the direction of the axis X and a radial direction is a direction perpendicular to this axis X and passing through it. Moreover, the circumferential (or tangential) direction corresponds to a direction perpendicular to the axis X and not passing through it. Unless otherwise specified, “inner” and “outer” are used with reference to a radial direction such that the inner part or face of an element is closer to the axis X than the outer part or face of the same element.

The vane 3 will thus be defined with respect to the axis X of the rotor associated with the static vane assembly 2 (whether it is the axis of rotation of the fan or of the propeller 26 for a fan guide vane, the axis of rotation of the rotor of the compressor for compression section guide vane 27 or else the axis of rotation of the rotor of the turbine for a turbine section nozzle 29 on which it is intended to be mounted.

In the remainder of the text, the invention will be described in the case of variable-pitch vanes 3, i.e. vanes 3 mounted pivotably about a pitch axis Y on the hub 4 of the vane assembly 2. This is however not limiting, the vanes 3 being able to be fixed with respect to the hub 4 when the fan is ducted, the hub 4 then corresponding to the shroud of the intermediate casing (which is located between the casing of the low-pressure compressor and the casing of the high-pressure compressor).

The static vane assembly 2 comprises a hub 4 mounted fixedly with respect to a casing 30 of the turbomachine 1. It is therefore non-rotary. The vanes 3 of the vane assembly 2 extend substantially radially with respect to the axis X.

The vanes 3 are here of variable pitch. The vane assembly 2 thus comprises an actuating mechanism 5 making it possible to modify the pitch angle of the vanes 3 of the vane assembly 2 in order to adapt the performance of the turbomachine 1 to the different flight phases. In addition, each vane 3 comprises a fastener 6 (or pivot) disposed at the vane root 8. The fastener 6 is mounted rotatably with respect to the hub 4 about the pitch axis Y. More precisely, the fastener 6 is mounted rotatably inside the housing fashioned in the hub 4, by way of balls or other rolling elements.

In a manner known per se, the fastener 6 comprises a wall having an outer surface having a shape of revolution. The outer surface can for example have circular grooves suitable for forming raceways 6a for balls or other rolling elements.

The vane 3 comprises an airfoil 7 with an aerodynamic profile suitable for being placed in an air stream when the turbomachine 1 is in operation in order to generate a lift, as well as a vane root 8 configured to be attached to the hub 4 of the vane assembly 2 by way of the fastener 6.

The aerodynamic-profile airfoil 7 is shaped so as to define a pressure face, a suction face, a leading edge 9 and a trailing edge 10. In a manner known per se, the leading edge 9 is configured to extend facing the flow of the gas entering the turbomachine 1. It corresponds to the anterior part of an aerodynamic profile which faces the air stream and which divides the air flow into a pressure face flow and a suction face flow. The trailing edge 10 meanwhile corresponds to the posterior part of the aerodynamic profile, where the pressure face and suction face flows meet.

The vane 3 comprises two skins 12, which are connected to one another and extend globally facing one another. In particular, the skins 12 are connected at the vane tip over the entire chord of the vane 3, at the level of the leading edge and at the level of the trailing edge. The skins 12 are made of a composite material comprising a fiber reinforcement 13 densified by a matrix. They may be monolithic and made of a single part from a fiber preform with a varying thickness. In a variant, the fiber reinforcement 13 may comprise a first skin 12 for the pressure face and a second skin 12 for the suction face, which are connected for example in proximity to the tip of the vane 3.

The fiber reinforcement 13 may comprise woven or knitted three-dimensional fiber arrangements. It is moreover produced so that it comprises warp yarns which extend continuously both inside the aerodynamic-profile airfoil part 7 and inside the vane root part 8. In a variant, the fiber reinforcement 13 may comprise laminate two-dimensional fiber arrangements. The fibers of the fiber reinforcement 13 comprise at least one of the following materials: carbon (typically silicon carbide), glass, aramid, polypropylene and/or ceramic (typically, an oxide ceramic). The matrix typically comprises an organic matrix (thermosetting, thermoplastic or elastomer) or a carbon matrix. For example, the matrix comprises a plastic material, typically made of polymer, for example epoxy bismaleimide or polyimide.

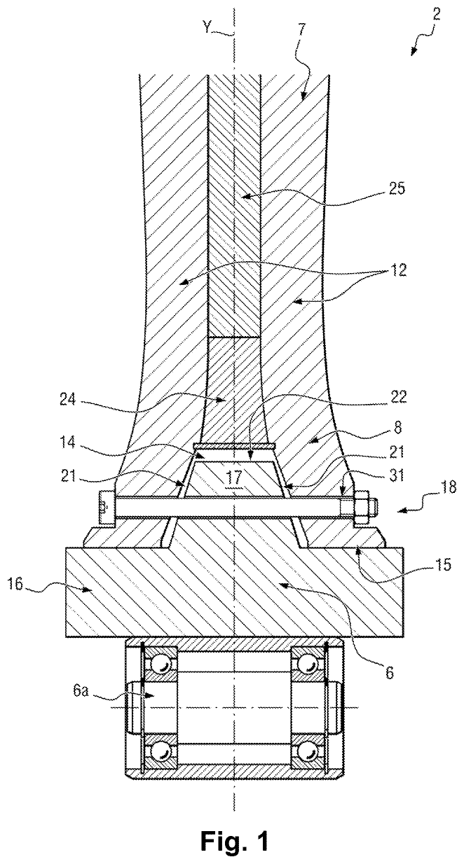

The skins 12 of the fiber reinforcement 13 are separated by a cavity 14 which is open onto a lower face 15 of the vane root 8, which makes it possible to further reduce the mass of the vane 3 by comparison with conventional vanes 3. Note that the lower face 15 of the vane root 8 corresponds to the face of the vane root 8 which is facing the platform 16 (shown further on and seen on FIGS. 1 and 3) of the fastener 6 when the vane root 8 is assembled with the fastener 6. The cavity 14 is not through (open) at the vane tip.

When the skins 12 are obtained by three-dimensional weaving and are monolithic, the cavity 14 is obtained by making a non-interlinking in the fiber blank between two successive warp layers, from a so-called non-non-interlinked area (here comprising the vane tip 3) all the way to the inner radial end of the skins 12, into which the cavity 14 opens. To do so, at the non-interlinking, the warp strands of two successive layers of the fiber blank are not connected by weft strands, which forms the cavity 14. Preferably, the non-interlinking extends within the aerodynamic-profile airfoil 7 and extends all the way to the lower face 15 of the vane root 8 (in order to allow the insertion of the rib 17 of the fastener 6). In the part of the blank intended to extend in the air stream (i.e. the aerodynamic-profile airfoil 7), the cavity 14 is not open onto the leading edge 9 or the trailing edge 10. The parts of the fiber blanks forming the leading edge 9 and the trailing edge 10 are therefore non-non-interlinked. On the other hand, in the part of the blank forming the vane root 8 (i.e. the area which is intended to be attached to the fastener 6), the cavity 14 can also be open onto the upstream 19 and downstream 20 edges of the vane root 8 (and which extend in the extension of the leading edge 9 and of the trailing edge 10 of the airfoil 7), respectively. The parts of the fiber blank forming the upstream edge 19 and the downstream edge 20 of the vane root 8 can therefore be non-interlinked.

One may refer by way of example to the document EP2588758 in the name of the Applicant for more details about the production of non-interlinkings.

The vane 3 may further comprise one or more filling parts 25, typically parts made of foam or any other suitable material having a lower density than the composite material of the skins 12, placed in the part of the cavity 14 extending within the aerodynamic-profile airfoil 7 in order to stiffen the skins 12 and/or give the skins 12 the final shape of the airfoil 7. The filling parts 25 for example have a density in the order of a hundred kg/m³ and a stiffness in the order of a hundred MPa. They may in particular comprise a foam, such as a foam of organic origin (polymethacrylimide, polyethylene terephthalate (PET), polyvinyl chloride (PVC), polyetherimide (PEI), polyvinyl, carbon, polyisocyanurate, polyurethane, etc.) or metallic (particularly made of aluminum alloy), or else a honeycomb of Nomex® type (comprising aramid fibers calendared into sheets and covered with phenolic resin), made of Kevlar®, glass fiber or else aluminum.

The fastener 6 is configured to receive the vane root 8 and to attach it to the hub 4 of the static vane assembly 2. For this purpose, the fastener 6 further comprises a platform 16 and a rib 17 protruding from the platform 16. The rib 17 is configured to enter into the cavity 14 such as to extend between inner faces 12a of the first skin 12 and of the second skin 12. The first and second skins 12 are moreover mechanically attached to the rib 17 by an attaching system 18. This configuration makes it possible to reliably attach the vane 3 to the hub 4, with a reduced radial and transverse bulk, by making use of the inner cavity 14 of the airfoil 7 (located between the two skins 12) in order to transmit the forces from the vane assembly 2 to the fastener 6. More precisely, the attaching system 18 traverses the first skin 12, the rib 17 and the second skin 12. The part of the fastener 6 which then bears against the vane root 8 is thus housed inside the vane root 8, so that it does not affect the radial or transverse bulk of the vane assembly 2—unlike conventional fasteners, which are placed outside the vane root 8 and therefore of necessity impinge on the available space in the vane assembly 2. It thus makes it possible to reduce the inter-part space and/or use the volume saved for other functions for the engine (channel or cable passage, addition of functions to the surrounding parts, etc.).

The rib 17 being housed in the cavity 14 of the vane root 8, its height (i.e. its dimension along the pitch axis Y) can be greater than the height of conventional fasteners, which improves the take-up of the moments generated by the aerodynamic forces. Since the rib 17 may have a significant height, it has greater bearing surfaces, which reduces bearing stresses (direction out of the plane).

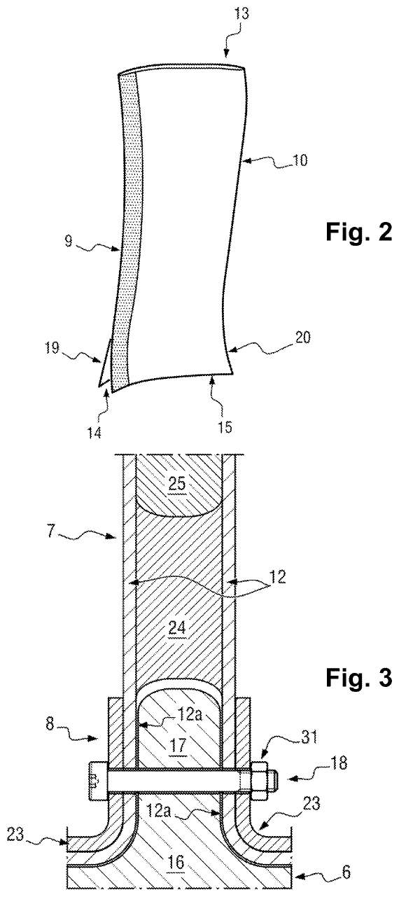

The rib 17 extends along the chord of the vane 3, between the upstream edge 19 and the downstream edge 20 of the vane root 8, which extend in the extension of the leading edge 9 and of the trailing edge 10 of the airfoil 7, respectively. Its form substantially follows the shape of the vane root 8. For example, the vane root 8 and the rib 17 can be substantially rectilinear. In a form of embodiment, and as indicated above, the cavity 14 can also be open onto the upstream edge 19 and the downstream edge 20 of the vane root 8. The rib 17 then extends along the entire cavity 13, from the upstream edge 19 all the way to the downstream edge 20 of the vane root 8, and the skins 12 are attached to the rib 17 over their entire length (along the axial direction, as illustrated on FIGS. 1 and 2).

The rib 17 comprises two side faces 21 and an apex 22. The side faces 21 are connected to the platform 16 at the level of a lower border, of a radius of curvature large enough to limit the concentrations of stresses. In a form of embodiment illustrated on FIG. 1, the side faces 21 are inclined and converge in the direction of the apex 22, such that the thickness of the rib 17 is greater in proximity to the platform 16 than to its apex 22. This configuration of the rib 17 thus makes it possible to adapt to the aerodynamic profile of the vane 3 and to facilitate the mounting of the vane root 8. In a variant (see FIG. 3), the side faces 21 are substantially parallel and extend globally parallel to the pitch axis Y. The thickness of the rib 17 is then substantially constant from the platform in the direction of the apex. In a form of embodiment, the side faces 21 are planar. In a variant, the side faces 21 may be curved and symmetrical with respect to a plane passing through the axis Y, the curvature of the side faces 21 being concave such that the thickness of the rib 17 decreases in the direction of the apex 22. A radius of curvature of the side faces 21 can then be between 15 mm and 25 mm. According to yet another variant, the side faces 21 may have a planar first part, for example parallel to the pitch axis Y or inclined in the direction of the apex 22, then curved all the way to the apex with a radius of curvature in the order of 20 mm.

In order to facilitate the mounting of the skins 12 on the fastener 6 and avoid any risk of blocking, the inner faces 12a of the skins 12 are more flared than the side faces 21 of the rib 17 (see FIG. 1). More precisely, the inner faces 12a of the skins 12 form a first angle with a plane of symmetry of the vane root 8 (plane normal to the figure comprising the pitch axis Y), and the side faces 21 form a second angle with this plane; the first angle is then greater than the second angle (see FIG. 1).

Preferably, the inner radial end of the skins 12 comes to bear against the platform 16. In the example illustrated on FIG. 1, the inner radial end of the skins 12 corresponds to the lower face 15 of the vane root 8. In the example illustrated on FIG. 3, the skins 12 are pushed down onto the rib 17 so that their inner face 12a is then in contact both with the side faces of the rib 17 and the platform 16. The inner radial end of the skins 12 is then their inner face 12a. Whatever the variant embodiment, the platform 16 and the inner radial ends (15/12a) of the skins 12 thus serve as reference surfaces for the radial positioning of the vane 3 with respect to the fastener 6.

The tangential position of the vane 3 is meanwhile provided by the contact of the inner faces 12a of the skins 12 with the rib 17, since the attaching system 18 presses the skins 12 of the vane 3 flat against the side faces 21 of the rib 17. The side faces 21 of the rib 17 and the inner faces 12a of the skins 12 therefore form the reference surfaces for the tangential position of the vane root 8 with respect to the fastener 6.

Optionally, the reference surfaces of the vane root 8 are produced by machining a sacrificial thickness of the composite material. The sacrificial thickness corresponds to a non-structural part of the vane 3, which can for example be obtained by the addition of plies of composite material, pre-impregnated and co-injected with the preform of the fiber reinforcement 13. The plies of composite material may in particular comprise glass fibers embedded in a matrix, preferably a matrix compatible with the matrix of the fiber reinforcement 13 of the skins 12 (typically the same matrix).

The attaching system 18 may comprise any suitable means for mechanically attaching the vane root 8 onto the fastener 6. For example, the attaching system 18 comprises a bolt 31 traversing the first skin 12, the rib 17 and the second skin 12. In a form of embodiment, the attaching system 18 comprises several bolts 31 distributed between an upstream end and a downstream end of the rib 17. The screws of the bolts 31 are then inserted into through passages formed in the skins 12 and the rib 17. One and the same bolt 31 thus traverses the two skins 12 and the rib 17.

When the rib 17 extends over the entire chord of the vane 3, the attaching system 18 comprises bolts 31 distributed equidistantly from the upstream edge 18 all the way to the downstream edge 20 of the vane root 8. For example, for a vane 3 of a guide vane of a turboprop of USF type, the attaching system 18 comprises between three and six bolts 31 distributed equidistantly between the leading edge 9 and the trailing edge 10 of the vane 3. Optionally, a spot-facing can be done in the outer face of the skins 12 in order to improve the bearing surface of the screw heads of the bolts 31.

In a variant or in addition, the attaching system 18 may comprise a metallic plate 23 (see FIG. 3) added on and attached by bolting onto each skin of the fiber reinforcement 13. Optionally, a spot-facing can be done in the plate 23 in order to improve the bearing surface of the screw heads of the bolts 31. The plate 23 can be substantially planar and be pressed flat against the corresponding skin 12 by the bolts 31. In the variant embodiment in which the inner faces 12a of the skins 12 are also in contact with the platform 16 (see FIG. 3 for example), the plate 23 can be bent and comprise a first portion configured to press the skin 12 facing the fiber reinforcement 13 flat against the corresponding side face 21 of the rib 17 and a second portion configured to press the free end of this same skin 12 flat against the platform 16.

The plate 23 (straight or bent) in particular makes it possible to help with the take-up of moments, particularly in the event of an object being ingested, and the dissipation of energy by plastic deformation in the event of a significant bending of the vane 3.

In a form of embodiment, the vane 3 further comprises a shaping part 24, placed in the cavity 14, in proximity to the apex 22 of the rib 17, in order to reinforce the stiffness of the vane 3 at the bottom of the airfoil 7. The shaping part 24 also has the aim of ensuring a gradual transition in stiffness in the radial direction, to avoid concentrations of stresses at the exit of the clamping area.

The shaping part 24 is positioned in the cavity 14 such as to extend in proximity to the rib 17 while fashioning a functional clearance between the shaping part 24 and the rib 17 in order to provide the mounting of the vane root 8. The clearance can be in the order of a few millimeters for example.

Where applicable, the shaping part 24 is placed between the apex 22 of the rib 17 and the filling part or parts 25.

The shaping part 24 may in particular be made of a composite material comprising a fiber reinforcement embedded in a matrix, preferably a matrix compatible with the matrix of the fiber reinforcement 13 of the skins 12 (typically, the same matrix). The fiber reinforcement of the shaping part 24 may in particular comprise fibers of a Young modulus greater than 5 GPa, for example fibers of carbon, aramid, glass or basalt.

### Method of Fabrication

A vane 3 in accordance with the invention may in particular be obtained in accordance with the following steps.

A fiber blank of the two skins 12 is produced, for example by weaving or knitting. In an exemplary embodiment, the fiber blank is woven in three dimensions with production of one or more non-interlinkings in order to obtain the two skins 12 and the cavity 14. The two skins 12 are monolithic at the level of the tip, the leading edge 9 and the trailing edge 10 of the airfoil 7. The cavity 14 is open onto the lower face 15 of the vane root 8 and extends all the way inside the airfoil 7.

In a variant, the skins 12 can be woven separately in two or three dimensions, then connected during curing (co-curing).

Where applicable, the cavity 14 is also open onto the upstream edge 19 and the downstream edge 20 of the vane root 8.

At least one filling part 25 is then placed at the bottom of the cavity 14. Then, at least one shaping part 24 is placed in the cavity 14, for example bearing against the filling part or parts 25. The shaping part 24 seals the cavity 14 and is positioned in such a way as to leave a clearance with the rib 17 after assembly.

Optionally, plies of pre-impregnated composite material are placed against the surfaces of the skins intended to form reference surfaces, namely the inner faces 12a of the skins 12, in the area intended to come into contact with the side faces 21 of the rib 17, and on the inner radial end of the skins 12.

The assembly formed by the fiber blank, the filling 25 and shaping 24 parts and where applicable the plies of composite material are placed in a mold having a recess having the shape of the molded final part (namely the airfoil 7 and the root of the vane 3) and the material (the “matrix” of the composite material), generally plastic, is injected into the mold in such a way as to impregnate the fiber reinforcement 13 of the skins 12 and the shaping and filling parts. The injection of the matrix can be done by a technique of injection of RTM or VARRTM type. In the case of a plastic, the matrix injected is for example a thermosettable liquid composition containing an organic precursor of the material of the matrix. The organic precursor usually takes the form of a polymer, such as a resin, where applicable diluted in a solvent. In a manner known per se, the plastic is then heated in such a way as to cause a polymerization of the plastic, for example by crosslinking. For this purpose, the mold is placed in an oven.

The part obtained is then removed from the mold then, optionally, trimmed by machining, in order to eliminate excess lengths and obtain a part having the desired shape, despite any shrinkage of the fibers of the fiber reinforcement 13 during the polymerization of the plastic. The sacrificial thicknesses are in particular machined in order to obtain the reference surfaces of the vane root 8. Through passages are moreover machined in the skins 12 in order to receive the attaching system 18. Where applicable, spot-facings are also machined around through passages.

The fastener 6 is then positioned on the vane root 8 by placing the rib 17 in the cavity 14, between the inner faces 12a of the skins 12. After insertion of the fastener 6, the apex 22 of the rib 17 preferably extends a short distance away from the shaping part 24.

Preferably, through passages, intended to receive the attaching system 18 and extending facing the through passages machined in the skins 12, are formed through the side faces 21 of the rib 17 before its insertion into the cavity 14.

Finally, the attaching system 18 is added on and attached to the skins 12 and the fastener 6 in order to secure the vane root 8 and the rib 17. For example, bolts 31 are inserted and attached in the through passages of the skins 12 and of the fastener 6.

The method of fabrication is therefore simpler than for vanes having conventional fasteners, the number of components needed for the fabrication of the vane 3 being reduced and the steps of weaving or knitting of the fiber preform being simplified.

1. A vane of a static vane assembly of a turbomachine comprising:
a vane root comprising a fiber reinforcement embedded in a matrix, the fiber reinforcement comprising a first skin and a second skin separated by a cavity open onto a lower face of the vane root;
a fastener configured to receive the vane root and to attach it to a hub of the static vane assembly, the fastener comprising a platform and a rib protruding from the platform, the rib being configured to enter into the cavity so as to extend between inner faces of the first skin and of the second skin; and
an attaching system configured to mechanically attach the first skin and the second skin to the rib of the fastener,
wherein the attaching system traverses the first skin, the rib and the second skin.

2. The vane according to claim 1, wherein the rib comprises two side faces connected to the platform and an apex connecting the two side faces, a thickness of the rib being decreasing from the platform in the direction of the apex.

3. The vane according to claim 2, wherein the inner faces of the first skin and of the second skin are more flared than the two side faces of the rib.

4. The vane as claimed in claim 1, wherein the rib comprises two side faces connected to the platform and an apex connecting the two side faces, a thickness of the rib being substantially constant from the platform in the direction of the apex.

5. The vane according to claim 1, wherein the first skin and the second skin are in abutment against the platform.

6. The vane according to claim 1, wherein the attaching system comprises at least one of the following elements: a bolt; a plate shaped to come into contact with an outer face of the first skin and of the second skin.

7. The vane according to claim 6, wherein the attaching system comprises a bolt, the bolt traversing the first skin, the rib and the second skin.

8. The vane according to claim 1, further comprising a shaping part housed in the cavity distant from an apex of the rib.

9. The vane according to claim 8, wherein the shaping part comprises an additional composite material comprising an additional fiber reinforcement embedded in an additional matrix, the additional fiber reinforcement comprising fibers having a Young modulus at least equal to 5 GPa.

10. The vane according to claim 8, further comprising a filling part housed in the cavity between the apex and the shaping part, the filling part being configured to comprise a material, a density of the material being less than the density of a composite material comprising the fiber reinforcement embedded in the matrix.

11. The vane according to claim 1, wherein the fiber reinforcement has an upstream edge and a downstream edge, the cavity being open onto at least one from among the upstream edge and the downstream edge.

12. The vane according to claim 1, wherein the fastener is a pivot.

13. The vane according to claim 9, wherein the fibers comprised in the additional fiber reinforcement are fibers of carbon, fibers of aramid, fibers of glass or fibers of basalt.
